(19) United States
(12) Patent Application Publication
(10) Pub. No.: US 2014/0311418 A1
(43) Pub. Date: Oct. 23, 2014

(54) TWO FINGER OR THREE FINGER PET BRUSH

(71) Applicant: Randy Jack, Cherokee Village, AR (US)

(72) Inventor: Randy Jack, Cherokee Village, AR (US)

(21) Appl. No.: 13/865,159

(22) Filed: Apr. 17, 2013

(51) Int. Cl. A01K 13/00

(52) U.S. Cl. CPC A01K 13/002
USPC 119/633

(57) ABSTRACT

A pet brush has an outwardly curved brush section integrally connected to a handle section. The brush section has bristles extending from the pet brush on the outward curve. The handle section extends inward from one end of the pet brush. The handle section has a spacer element and a gripping element. Two or three fingers of the user can grip the upper surface of the gripping element while the first digits of the two or three fingers will curl under to grip the lower surface of the gripping element. The spacer element provides enough space for the first digits of the two or three fingers to fit under the gripping element and above the brush section. The outwardly curved brush section has a first radius of curvature at one end and a smaller, second radius of curvature at the handle section, second end.

### CROSS -REFERENCE TO RELATED APPLICATIONS

This application claims the benefit of U.S. Provisional Patent Application Ser. No. 61/635,124, which was filed on Apr. 18, 2012, which is herein incorporated by reference.

### BACKGROUND OF THE INVENTION

This invention relates generally to a pet brush and, more particularly, this invention is directed to a pet brush controlled by two or three fingers of the user and designed for grooming small animals.

Conventional pet brushes fall into two broad categories: hand brushes and handle brushes.

A hand brush is made of wood or plastic. It has an oval shape. The lower surface of the hand brush is flat with bristles sticking out to brush the animal. The upper surface can be flat or outwardly curved.

In use, the palm of the user is pressed against the oval upper surface with the thumb and fingers gripping the outer edge of the hand brush. The user than brushes the pet.

The size of the hand brush is larger than the palm of the average user. The hand brush is sometimes referred to as a palm brush.

A handle brush has a brush head connected to a brush handle. The brush head and the brush handle form along a single axial centerline. The lower surface of the brush head is flat with bristles sticking out to brush the animal. The upper surface can be flat or outwardly curved. The brush handle is typically cylindrical or ovoid in shape.

In use, the palm of the user presses against the upper surface of the brush handle with the fingers gripping the sides and lower surface of the brush handle. The user than brushes the pet.

Most conventional pet brushes have a large flat brushing surface. Small animals have curved and irregular body surfaces. It becomes problematic for a user to manipulate a large flat brush to quickly and adequately brush and groom a small animal, such as a small dog or cat.

Large brushes allow small animals to see the brush, potentially scaring the small animal. Large brushes may cause discomfort to a small animal by large numbers of bristles pulling at the small animal's hair and attached skin.

It is difficult for large brushes to reach small areas on a small animal and it is equally difficult for large brushes to groom small areas on a small animal.

Conventional pet brushes cannot be easily carried hands-free. Conventional pet brushes cannot be easily carried on a user's belt or in a user's pocket.

Conventional brushes take up large areas when resting on flat surfaces. The bristles are either down and possibly being broken or misaligned or are up, making it difficult to pick up the brush.

Handle brushes lead to repetitive stress to arms, wrists and hands of the user. When grooming a pet, the brush is typically pushed or pulled along a direction that is generally perpendicular to the handle axis. This repetitive stress alone can cause considerable strain and fatigue, especially where a user spends a good deal of time brushing.

The purpose of this present invention is to provide a better pet brush for small animals.

An object of this invention is to provide a pet brush that can be gripped and controlled by two or three fingers.

Another object of this invention is to provide a pet brush that has two different bristles for dematting and for grooming.

### SUMMARY OF THE INVENTION

This invention discloses a pet brush has an outwardly curved brush section integrally connected to a handle section. The brush section has bristles extending from the pet brush on the outward curve. The handle section extends inward from one end of the pet brush.

The outwardly curved brush section has a first section with a first radius of curvature at one end and a second section with a second radius of curvature at the handle section, second end. The second radius of curvature is smaller than the first radius of curvature.

The handle section has a spacer element and a gripping element. Two or three fingers of the user can grip the upper surface of the gripping element while the first digits or the first and second digits of the two or three fingers will curl under to grip the lower surface of the gripping element. The spacer element provides enough space for the first digits of the two or three fingers to fit under the lower surface of the gripping element and above the upper surface of the brush section.

The lower gripping surface of the gripping element can have ridges, etched ridges, dimples, reversed dimples or a tactile or sticky surface for improved gripping. The lower gripping surface of the gripping element can be formed of a different plastic or polymer material (from the rest of the pet brush) for improved gripping.

Alternately, the brush section of the pet brush can have the same radius of curvature from the first end to the second end with the handle section.

The bristles of the pet brush can be formed of different bristle materials. The brush section of the pet brush can have a first row of dematting bristles followed by rows of untangling and/or grooming bristles to better brush a pet.

The pet brush can hook onto a belt or pocket for carrying or freeing both hands of the user. The gripping element of the handle section of the pet brush is inside the belt, the spacer element is on top of the belt and the brush section is outside the belt. The same configuration also allows the pet brush to be hooked to a pocket.

The pet brush of the present invention can easily rest on any flat surface with the spacer element providing a base or the first end of the brush section and the upper surface of the gripping element providing a base.

### BRIEF DESCRIPTION OF THE DRAWINGS

A more detailed understanding of the present invention, as well as other objects and advantages thereof not enumerated herein, will become apparent upon consideration of the following detailed description and accompanying drawings, wherein:

FIG. 1 is a side view of the pet brush of the present invention.

FIG. 2 is a top view of the pet brush of the present invention of FIG. 1.

FIG. 3 is a side view of fingers gripping the handle section of the pet brush of the present invention.

FIG. 4 is a top view of two fingers gripping the handle section of the pet brush of the present invention of FIG. 3.

FIG. 5 is a side view of the thumb resting on the brush section of the pet brush of the present invention of FIG. 4.

FIG. 6 is a side view of the ring finger and the little finger resting on the brush section of the pet brush of the present invention of FIG. 4.

FIG. 7 is a top view of three fingers gripping the handle section of the pet brush of the present invention of FIG. 3.

FIG. 8 is a side view of an alternate embodiment of fingers gripping the handle section of the pet brush of the present invention.

FIG. 9 is a side view of the pet brush of the present invention with one radius of curvature.

FIG. 10 is a side view of two different bristles in the brush section of the pet brush of the present invention.

FIG. 11 is a side view of the pet brush of the present invention hooked to a belt.

FIG. 12 is a side view of the pet brush of the present invention resting on a flat surface with the spacer element as its base.

FIG. 13 is a side view of the pet brush of the present invention resting on a flat surface with the first end of the brush section and the upper surface of the gripping element as its base.

### DETAILED DESCRIPTION OF DRAWINGS

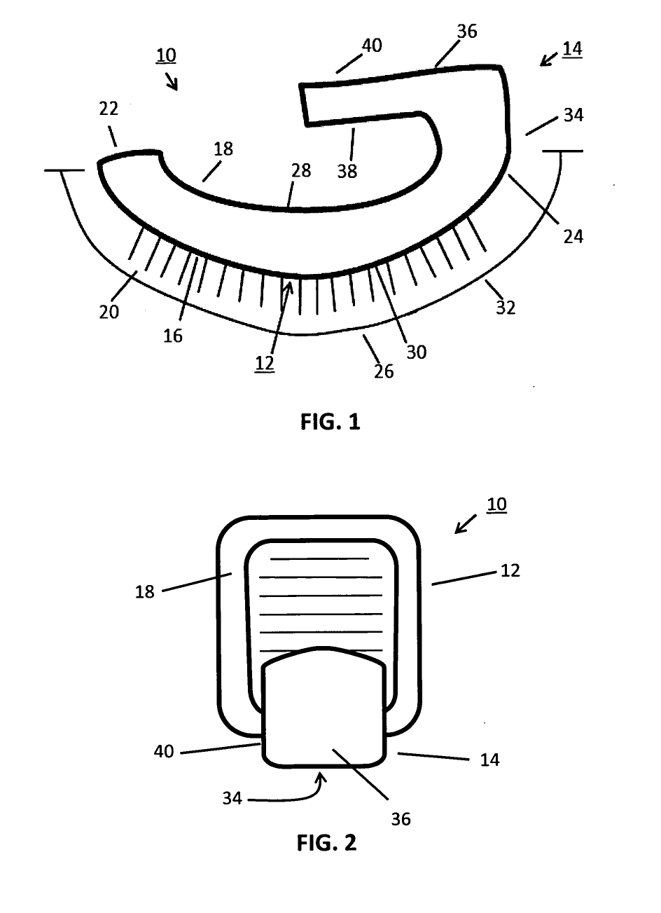

FIGS. 1 and 2 shows the pet brush 10 of the present invention with an outwardly curved brush section 12 integrally connected to a handle section 14. The brush can be formed of a plastic or polymer material. The brush is designed to groom small animals such as cats or small dogs or the like.

The outwardly curved brush section 12 has a lower surface 16 and an upper surface 18. Bristles 20 are attached to the lower surface 16 and extend into the brush section 12 of the pet brush 10. The bristles can be formed of metal wire such as stainless steel, bronze, silver, carbon steel or other materials; synthetic materials such as nylon, carbon fiber, polyester, polyethylene, polypropylene, PTFE, PVC, or other materials; vegetable fibers; and animal hair fibers; or a combination of two or more different bristle materials. The bristles can be formed with different bristle sizes, lengths, thickness or density in rows, columns, patterns or random.

The brush section has a first end 22 and second end 24. The handle section 14 is integrally connected at an angle to the second end 22 of the brush section 12.

The brush section 12 has an outward curve. This curve can also be described as convex or bow.

The brush section 12 has a first section 26 with a first radius of curvature at the first end 22 of the brush section 12 extending past the midpoint 28 of the brush section to a transition point 30 on the brush section. The brush section 12 has a second section 32 with a second radius of curvature from the transition point 30 (past the midpoint 28 of the brush section) to the second end 24 of the brush section. This second radius of curvature is different from the first radius of curvature. This second radius of curvature is smaller than the first radius of curvature.

The handle section 14 has a spacer element 34 and a gripping element 36.

The spacer element 34 extends away from the upper surface 18 of the second end 24 of the brush section 12. The gripping element 36 extends laterally from the spacer element 34 above the upper surface 18 of the brush section 12.

The spacer element 34 can be slightly outwardly curved or flat. The gripping element 36 can be flat or slightly outwardly curved. The gripping element 36 has a lower surface 38 and an upper surface 40.

The gripping element 36 is approximately planar with the first end 22 of the brush section 12 or perpendicular with the upper surface 18 of the brush section 12 adjacent to the first end of the brush section.

The spacer element 34 is at an approximate right angle to the gripping element 36 and is angled relative to the upper surface 18 of the second end 24 of the brush section 12. The spacer element and the gripping element form an inverted L shape.

The spacer element 34 has a height greater the average depth of the fingers of the user. This height allows the fingers to grip the lower surface of the gripping element.

The lower surface 38 of the gripping element 36 will be spaced from the nearest adjacent upper surface 18 of the brush section 12 by a distance exceeding the depth of the average fingers of the user. The spacing allows the fingers gripping the lower surface of the gripping element to fit between the gripping element and the upper surface of the brush section.

The gripping element 36 has a width greater than the width of the three fingers (the index finger, the middle finger and the ring finger) of the user. This width allows two or three fingers to grip the gripping element.

The lower surface 38 of the gripping element has a length equal to or greater than the first digit of the middle finger (the longest finger) of the user. This length allows the fingers gripping the gripping section by the first digit or the first and second digit.

The upper section 18 of the brush section has a length greater than the first two digits of the middle finger (the longest finger) of the user. This length allows the finger gripping the gripping section to fit within the curve of the brush section.

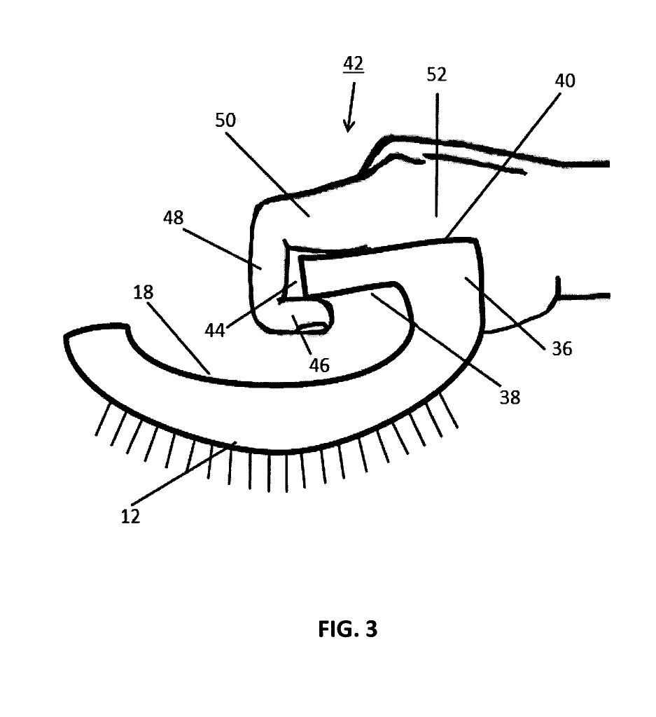

In use, as shown in FIG. 3, the index finger 42 curls around the upper surface 40, the front side 44 and under the lower surface 38 of the gripping element 36. For ease of understanding, the thumb and other fingers are not shown in this Figure. However, the digits of each finger in the two finger or three finger operation will be positioned and function as the digit of the index finger.

The first digit 46 of the index finger 42 will grip the lower surface 38 of the gripping element 36 of the handle section 14. The spacer element 34 is high enough so the index finger fits between the lower surface 38 of the gripping element and the upper section 18 of the second section 28 of the brush section 12. The upper surface of the brush element and the gripping element are long enough for one digit of the fingers to fit under the gripping element

The second digit 48 of the index finger 42 grips the front section 44 of the gripping element 36.

The third digit 50 of the index finger 42 and possibly a portion of the upper palm 52 (if the user has a small hand) will grip the upper surface 40 of the gripping element 36.

FIG. 3 shows one digit of the fingers gripping the lower surface of the gripping element of the handle section of the pet brush of the present invention.

The gripping element of the handle section of the pet brush can be gripped by two finger (the index finger and the middle finger) or three fingers (the index finger, the middle finger and the ring finger) of the user.

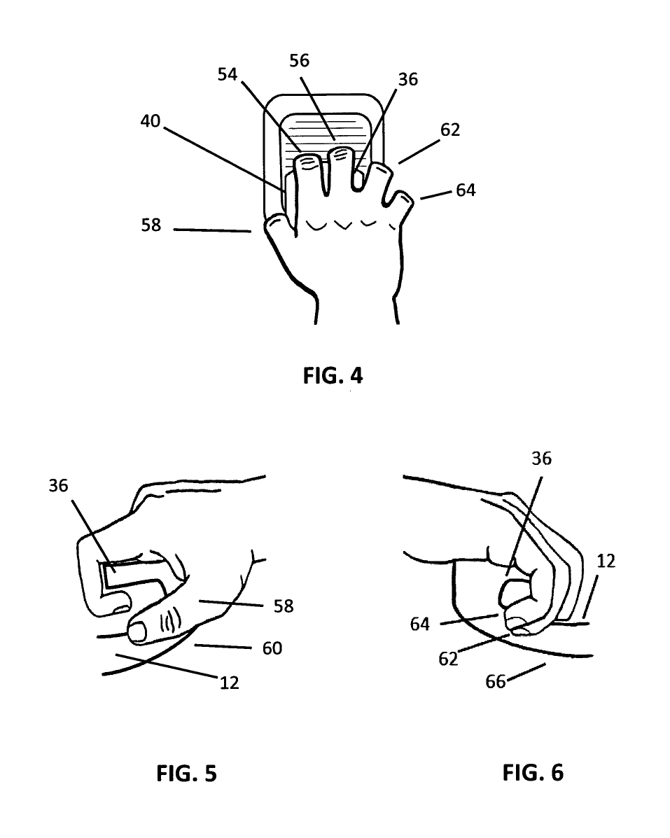

As shown in the FIG. 4, the two fingers of the index finger 54 and the middle finger 56 grip the upper surface 40 of the gripping element 36. The thumb 58 of the user will rest on the index finger 54 or rest on the first side 60 of the brush section 12 as shown in the FIG. 5.

The ring finger 62 and the little finger 64 can rest either on the second side 66 of the brush section 12 as shown in the FIG. 6; or the little finger will rest on the ring finger and the ring finger, will rest on the middle finger; or the ring finger can rest on the second side of the brush section and the ring finger will rest on the middle finger.

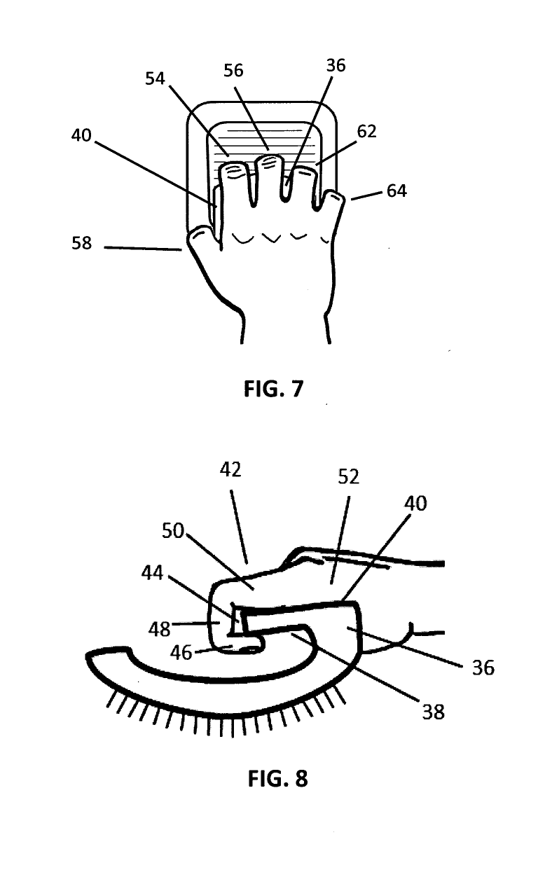

As shown in FIG. 7, the three fingers of the index finger 42, the middle finger 56 and the ring finger 62 grip the upper surface 40 of the gripping element 36. The thumb 58 of the user will rest on the index finger or rest on the first side of the brush section as shown previously.

The little finger 64 can rest either on the second side of the brush section as shown previously; or the little finger will rest on the ring finger.

Alternately, as shown in FIG. 8, the index finger 42 curls around the upper surface 40, the front side 44 and under the lower surface 38 of the gripping element 36. For ease of understanding, the thumb and other fingers are not shown in this Figure. However, the digits of each finger will be positioned and function as the digit of the index finger.

The first and second digits 46, 48 of the index finger 42 will grip the lower surface 38 of the gripping element 36 of the handle section 14. The upper surface of the brush element and the gripping element are long enough for two digits of the fingers to fit under the gripping element.

The third digit 50 of the index finger 42 grips the front section 44 of the gripping element 36.

A portion of the upper palm 52 will grip the upper surface 40 of the gripping element 36.

The gripping element of the handle section of the pet brush can be gripped by two finger (the index finger and the middle finger) or three fingers (the index finger, the middle finger and the ring finger) of the user.

The thumb and fingers will grip the sides of the brush section or rest against other fingers as detailed in the previous two figures.

FIG. 8 shows two digits of the fingers gripping the lower surface of the gripping element of the handle section of the pet brush of the present invention.

The two or three finger grip on the gripping element of the handle section of the pet brush of the present invention permits downward, upward or sideways motion of the bristles on the brush. This provides a gentle, effective brushing and grooming of the small animal.

The two or three finger grip on the gripping element of the handle section of the pet brush of the present invention allows the pet brush to reach and groom small areas on the pet's hair. The brush basically becomes part of the hand and fingers which hides the pet brush somewhat to make it less threatening when approaching various pets for grooming.

The pet brush of the present invention has no extending handle and is a more compact design with a comparable size bristle section.

Handle brushes lead to repetitive stress to arms, wrists and hands of the user. The brush is typically pushed or pulled along a direction that is generally perpendicular to the handle axis during grooming. This can cause considerable strain and fatigue, especially where a user spends a good deal of time brushing.

The pet brush of the present invention the hand, wrist and arm of the user can move in substantially the same downward, upward or sideways direction in which the brush is moved. In this way, hand, wrist or arm fatigue during operation can be avoided due to this positioning and minimal actuation of wrist muscles during usage.

The lower gripping surface of the gripping element can have ridges, etched ridges, dimples, reversed dimples or a tactile or sticky surface for improved gripping. The lower gripping surface of the gripping element can be formed of a different plastic or polymer material (from the rest of the pet brush) for improved gripping.

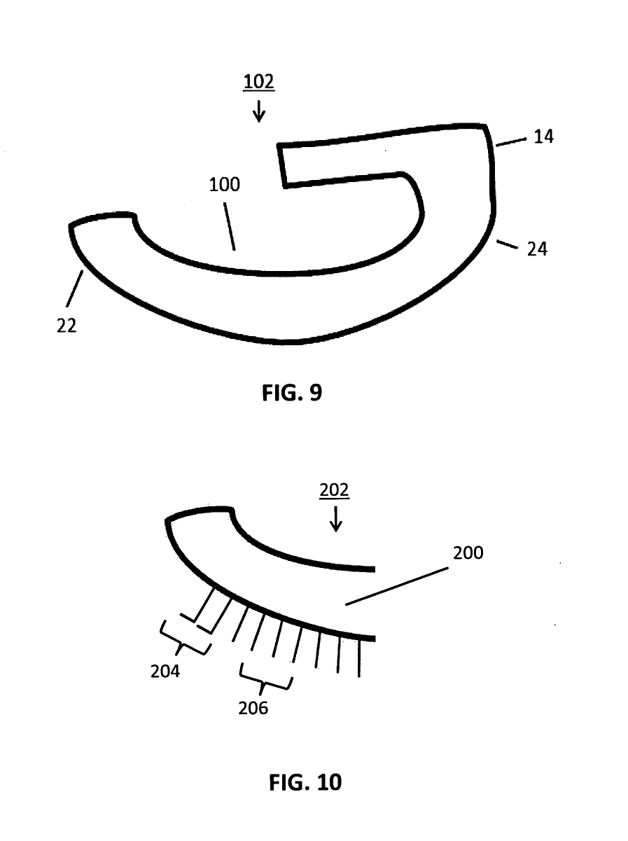

As shown in FIG. 9, the brush section 100 of the pet brush 102 can have the same radius of curvature from the first end 22 to the second end 24 with the handle section 14. The pet brush 102 is otherwise the same as the pet brush 10 of the previous Figures.

As noted, the bristles can be formed of different bristle materials. As shown in FIG. 10, the brush section 200 of the pet brush 202 has a first row of dematting bristles 204 followed by rows of grooming bristles 206 to better brush a pet. The dematting bristles will be at the initial contact with the pet hair. The brush section can have multiple rows of dematting bristles followed by rows of untangling and/or grooming bristles to better brush a pet.

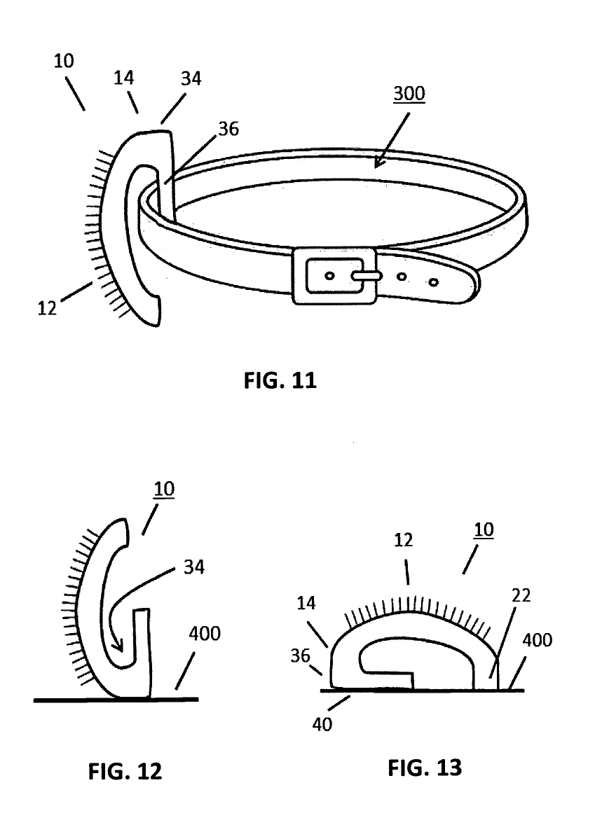

The pet brush 10 can hook onto a belt 300 or pocket for carrying or freeing both hands of the user. As shown in FIG. 11, the gripping element 36 of the handle section 14 of the pet brush is inside the belt 300, the spacer element 34 of the handle section 14 is on top of the belt 200 and the brush section 12 is outside the belt. The same configuration also allows the pet brush to be hooked to a pocket.

The pet brush 10 of the present invention can easily rest on any flat surface 400. As shown in FIG. 12, the pet brush 10 can be positioned with the spacer element 34 providing a base to rest on the flat surface 400. As shown in FIG. 13, the pet brush 10 can be positioned with the first end 22 of the brush section 12 and the upper surface 40 of the gripping element 36 of the handle section 14 providing a base to rest on the flat surface 400. Alternately, the pet brush 10 can be positioned with the first end 22 of the brush section 12 and the back side 402 of the gripping element 36, adjacent to the spacer element, of the handle section 14 providing a base to rest on the flat surface 400.

The brush material and the bristles material of the pet brush of the present invention allow the pet brush to be cleaned and/or disinfected in hot water, alcohol or other cleaning and/or disinfecting liquids.

While the invention has been described with the inclusion of specific embodiments and examples, it is evident to those skilled in the art that many alternatives, modifications and variations will be evident in light of the foregoing descriptions. Accordingly, the invention is intended to embrace all such alternatives, modifications and variations that fall within the spirit and scope of the appended claims.

1. A pet brush comprises
an outwardly curved brush section, said outwardly curved brush section have a lower surface and an upper surface, bristles extending outward from said lower surface of said outwardly curved brush section, said outwardly curved brush section having a first end and a second end; and
a handle section, said handle element being integrally connected to brush section, said handle section having a spacer element and a gripping element,
said spacer element extending from said second end of said outwardly curved brush section,
said gripping element extending laterally from said spacer element above said upper surface of said outwardly curved brush section

2. The pet brush of claim 1 wherein
said outwardly curved brush section has a first section with a first radius of curvature at said first end of said outwardly curved brush section, and a second section with a second radius of curvature at said second end of said outwardly curved brush section, said second radius of curvature being smaller than said first radius of curvature

3. The pet brush of claim 1 wherein
the height of said spacer element is greater than the depth of the fingers of the user of said pet brush; and the width of the upper surface of said gripping element is greater than the width of the index finger, the middle finger and the ring finger of said use; wherein two fingers or three fingers of said hand of said user can grip said gripping element.

4. The pet brush of claim 2 wherein
the height of said spacer element is greater than the depth of the fingers of the user of said pet brush; and the width of the upper surface of said gripping element is greater than the width of the index finger, the middle finger and the ring finger of said use; wherein two fingers or three fingers of said hand of said user can grip said gripping element.

5. The pet brush of claim 1 wherein said brush section has two different bristles.

6. The pet brush of claim 5 wherein said two different bristles are first bristles for dematting and second bristles for grooming, said first bristles having first contact with the hair of said pet.

7. The pet brush of claim 2 wherein said brush section has two different bristles.

8. The pet brush of claim 7 wherein said two different bristles are first bristles for dematting and second bristles for grooming, said first bristles having first contact with the hair of said pet.

9. The pet brush of claim 2 wherein
the height of said spacer element is greater than the depth of the fingers of the user of said pet brush; and the width of the upper surface of said gripping element is greater than the width of the index finger, the middle finger and the ring finger of said use; wherein two fingers or three fingers of said hand of said user can grip said gripping element; and
said brush section has two different bristles, said two different bristles are first bristles for dematting and second bristles for grooming, said first bristles having first contact with the hair of said pet.
